(19) United States
(12) Patent Application Publication
(10) Pub. No.: US 2026/0256276 A1
(43) Pub. Date: Sep. 3, 2026

(54) CLEANING DEVICE, METHOD FOR CLEANING AND USE OF A CLEANING DEVICE FOR FAST-MOVING SURFACES

(71) Applicant: Wandres GmbH, Stegen (DE)

(72) Inventor: Claus G. WANDRES, Stegen (DE)

(73) Assignee: Wandres GmbH, Stegen (DE)

(21) Appl. No.: 19/163,087

(22) PCT Filed: Mar. 8, 2024
(86) PCT No.: PCT/EP2024/056252

§ 371 Date: Sep. 8, 2025

(30) Foreign Application Priority Data
Mar. 10, 2023 (DE) 10 2023 106 044.9

(51) Int. Cl. A46B 15/00; A46B 5/00; A46B 5/06; A46B 13/04; A46B 17/06; B08B 1/16; B08B 1/20; B08B 1/50; B08B 5/04

(52) U.S. Cl. CPC A46B 15/0053; A46B 5/0012; A46B 5/06; A46B 13/04; A46B 17/06; B08B 1/165; B08B 1/20; B08B 1/50; B08B 5/04; A46B 2200/3073

(57) ABSTRACT

In a cleaning device (1) having at least two cleaning elements (7) that are spaced apart and rotatable, the cleaning elements (7) have movable bristles (12), and a suction device (2) is arranged between the at least two cleaning elements (7).

### CROSS-REFERENCE TO RELATED APPLICATIONS

This application is a 371 National Phase of International Application PCT/EP2024/056252, filed Mar. 8, 2024, which claimed priority to German Patent Application No 10 2023 106 044.9, filed Mar. 10, 2023, both of which are incorporated herein by reference as if fully set forth.

### TECHNICAL FIELD

The invention relates to a cleaning device, in particular for fast-moving surfaces, having at least two cleaning elements that are spaced apart and movable, for example rotatable, wherein the cleaning elements have movable bristles. Such a cleaning device has many practical applications.

The invention further relates to a method for cleaning a contaminated surface. Such a method is known in the prior art.

The invention further relates to the use of a cleaning device. Such a use is known.

### BACKGROUND

In the prior art, it is often the case that moving surfaces which are contaminated with dirt particles and have a speed of, for example, 1 meter per second or higher can only be cleaned inadequately because the dirt particles often stick. This is where the invention comes in and eliminates the disadvantages of the prior art.

### SUMMARY

The invention is based on the object of improving the operating characteristics of a cleaning device, in particular improving the cleaning of fast-moving surfaces. The object is solved by a leaning device with one or more of the features disclosed herein. Advantageous designs are described below and in the claims.

It should be noted that the features listed individually in the dependent claims can be combined with each other in any technologically meaningful way and define further designs of the invention. In addition, the features specified in the claims are further specified and explained in the description, wherein further preferred designs of the invention are presented.

To solve this object, the invention proposes one or more of the features disclosed herein. In particular, the invention proposes that, in a cleaning device of the type described above, a suction device is arranged between the at least two cleaning elements to solve the aforementioned problem. Thus, the wiping effect of the cleaning elements in combination with suction can achieve advantageous cleaning of a dirty and moving surface. This is particularly effective for surface speeds in the range of 10 meters per second and higher.

The suction device is located directly between the at least two cleaning elements and perpendicular and above the moving surface to be cleaned. The suction device is arranged along a normal vector of the moving surface. Between the at least two cleaning elements can mean that the suction device is physically located there. Although suction devices are known in the prior art, they are not located between the cleaning elements, but typically at a head or foot area of the cleaning elements.

The cleaning elements can have movable bristles.

To solve this object, the invention proposes further features disclosed herein. In particular, the invention proposes that, in a cleaning device of the type described above, the cleaning elements have different permeability in order to solve the aforementioned object. The permeability is preferably designed with regard to fluids. A fluid is described here as a substance that is gaseous or liquid. This allows different fluids to flow through the at least two cleaning elements and targeted cleaning to be carried out. This leads to improved cleaning quality.

Permeability refers to the flowability of the cleaning elements, wherein permeability is expressed in meters squared.

In an advantageous design, it may be provided that a transport device is formed which causes a relative movement of a contaminated surface to the at least two cleaning elements in a transport direction. The speed of the contaminated surface can be 10 meters per second or more. This increases the cleaning ability of the cleaning device.

In an advantageous design, it may be provided that the at least two cleaning elements are designed as bristle rollers and additionally or alternatively as bristle belts. This allows cleaning elements to be provided depending on the situation and the degree of contamination.

Bristle rollers are cylindrical objects that have bristles and can perform a rolling movement. Bristle belts, on the other hand, are similar to a belt and have a direction of movement that runs along the belt. Bristle belts therefore have a direction of movement that is transverse, preferably orthogonal, to the direction of transport of the transport device. Bristle rollers, on the other hand, have a direction of movement that runs along the direction of transport.

The contaminated surface can be a wooden surface, a plastic surface, a metal surface, a glass surface, or a paper surface.

In an advantageous design, it may be provided that a negative pressure prevails between the at least two cleaning elements. This negative pressure is preferably provided or generated by the suction device. This allows dirt particles detached from the surface to be easily sucked away.

In an advantageous design, it may be provided that the distance between the bristles and the contaminated surface is not constant in an area of the surface. The area of the surface is preferably a lateral area of the surface. This is intended to ensure that the area of the surface is not damaged by the rotating cleaning elements or that the rotating cleaning elements are not damaged by the lateral area of the surface.

The contaminated surface is in particular a strip-shaped surface.

In an advantageous design, it may be provided that the cleaning elements can be arranged to move in a direction that is transverse, in particular orthogonal, to the transport direction of the contaminated surface. The bristles of the cleaning elements clean the contaminated surface of dirt particles by their rotary movement, whereupon these are then guided between the at least two cleaning elements and sucked away from the suction device. The transverse arrangement of the transport direction to the direction of movement improves the cleaning properties of the cleaning elements.

In this application, an angle between 85° and 95° is understood to be orthogonal. In this application, an angle greater than 0° and less than 90° is referred to as transverse.

In an advantageous design, it may be provided that one of the at least two cleaning elements may be provided with flow channels transverse to the transport direction of the contaminated surface. Preferably or alternatively, the flow channels are designed transversely to the direction of movement of the at least two cleaning elements. Dirt particles can be guided through the flow channels of the cleaning elements, wherein a negative Coanda effect can occur due to the suction effect of the suction device. The Coanda effect refers to various phenomena that suggest a tendency of a gas jet or a liquid flow to run along a convex surface instead of detaching and continuing to move in the original direction of flow.

In an advantageous design, it may be provided that the at least two cleaning elements may be provided with the same permeability. This can be advantageous, for example, for certain contaminated surfaces. This increases the flexibility of the cleaning elements with regard to the contaminated surface.

In an advantageous design, it may be provided that the flow channels may be formed by bristles of different lengths or by a bristle-free partial body located on the cleaning element. This allows the permeability of the cleaning elements to be adapted to the specific situation, in particular depending on the speed of the contaminated surface and the degree of contamination.

In an advantageous design, it may be provided that the cleaning elements are operated in opposite or in the same direction, in particular where one, for example the aforementioned, direction of movement of the cleaning elements is in the same direction or in opposite directions. The setting of the direction of movement depends, for example, on the degree of contamination and/or the type of material to be cleaned.

In an advantageous design, it may be provided that scrapers are formed. The scrapers are preferably arranged at a reversal point of the cleaning elements. In addition or alternatively, the scrapers contact the cleaning elements and scrape dirt particles from the cleaning elements, in particular from the bristles. In this way, the cleaning elements can be cleaned with the aid of the scrapers and prevent dirt particles from simply circulating in the direction of movement of the cleaning elements.

In an advantageous design, it may be provided that the scrapers comprise a separate suction unit which sucks off the dirt particles stripped off by the scrapers. The suction unit may be designed separately or as part of the suction device. This prevents the dirt particles from sticking to the bristles and merely circulating in the direction of movement.

In an advantageous design, it may be provided that the at least two cleaning elements may have flow channels of different dimensions and permeabilities. The flow channels are preferably arranged transversely to one, for example the aforementioned, direction of movement of the cleaning elements. This allows the cleaning elements to be adapted to the type of dirt particles, the material of the contaminated surface, and the speed of the transport device.

The permeabilities can be adjusted by the dimensions and design of the flow channels. A cleaning element without flow channels has a lower permeability than a cleaning element with flow channels.

In an advantageous design, it may be provided that the flow channels can be designed to be straight. This can have a positive effect on the mobility of the dirt particles through the cleaning elements.

In an advantageous design, it may be provided that an angle α between a longitudinal axis of the flow channels and a width of the cleaning element is between 0° and 60°. Such an angle has proven to be particularly advantageous in experiments.

In an advantageous design, it may be provided that the suction device may comprise a collection unit for collecting dirt particles. This allows dirt particles to be elegantly removed from the circulation of the cleaning elements and collected in a functional manner. This is particularly relevant for larger and heavier dirt particles that cannot be easily removed by the suction device.

A collection unit is understood to be a unit in which a concentration of dirt particles increases and these accumulate within the collection unit and are not transported away from there by means of suction. It is preferable for the dirt particles to be removed from the collection unit manually, in particular by hand. Heavy dirt particles that cannot be extracted by the suction device tend to accumulate in the collection unit.

In an advantageous design, it may be provided that the cleaning element upstream of the contaminated surface in the direction of transport has a higher permeability than the downstream cleaning element. This improves the cleaning function, as dirt particles can pass through the first cleaning element more easily and have greater difficulty passing through the cleaning element behind it.

In an advantageous design, it may be provided that the aforementioned angle α is different for two cleaning elements of the at least two cleaning elements. This allows the permeability of the cleaning elements to be precisely adapted to the cleaning situation. For example, the two cleaning elements can be mirrored to each other, or the two flow channels can be arranged at different angles in terms of magnitude.

In an advantageous design, it may be provided that the suction device may have a slot opening whose width is smaller than the distance between the at least two cleaning elements and through which the dirt particles can be extracted. This allows for advantageous circulation or flow in the suction device, which is beneficial for cleaning.

In an advantageous design, it may be provided that a (single-part or multi-part) slot opening, for example the one already mentioned, which is designed for extracting dirt particles, has a longitudinal extension (L1) which is greater than half, in particular greater than three quarters, of the length of at least one of the cleaning elements. This allows suction to be achieved over a complete and/or as uniform as possible extension of a workpiece to be cleaned transverse to its direction of transport.

The longitudinal extension can be provided, for example, by a distance between the ends of a (single-piece) slot forming the slot opening or a (multi-piece) slot arrangement, or by the sum of the clear internal dimensions of a (multi-piece) slot arrangement.

In an advantageous design, it may be provided that the suction device comprises a funnel-shaped base body, in the bottom of which the slot opening and the collection unit are formed adjacent to each other. This provides advantageous flow dynamics in the base body, which is beneficial for the removal of dirt particles.

The bristles are preferably open at the sides.

In an advantageous design, it may be provided that the at least two cleaning elements can be arranged on both sides and mirror-symmetrically to the contaminated surface. This allows both sides of the surface to be cleaned efficiently.

In an advantageous design, it may be provided that two suction devices are formed, which are arranged on both sides and mirror-symmetrically to the contaminated surface. This allows both sides of the surface to be cleaned efficiently.

In an advantageous design, it may be provided that the transport direction of the contaminated surface and one, for example the aforementioned, direction of movement of the cleaning elements are arranged transversely, in particular orthogonally, to each other. This improves the cleaning ability of the cleaning device, as the dirt particles can be removed more easily from the surface when the direction of movement is transverse to the transport direction.

In an advantageous design, it may be provided that the at least two cleaning elements have a step, wherein in a region in front of the step, the bristles of the cleaning element are raised from the contaminated surface. This is particularly advantageous in an edge region of the surface, as this prevents the surface from being damaged or torn off by the rotation of the cleaning elements.

In order to solve the aforementioned object, the invention provides the features as disclosed herein relating to a method for cleaning a contaminated surface. In particular, to solve the aforementioned object, the invention proposes a method of the type described above in which dirt particles are guided through at least two different permeable and movable cleaning elements, wherein the cleaning elements comprise bristles, and are sucked off by a suction device located between the at least two cleaning elements. This improves the cleaning quality.

In an advantageous design, it may be provided that the at least two cleaning elements are cleaned of dirt particles by scrapers which contact the at least two cleaning elements at their ends. This prevents the dirt particles from adhering to the cleaning elements and merely circulating along the direction of movement.

In an advantageous design, it may be provided that the bristles of the cleaning elements are guided out of a cleaning area for their own cleaning. This prevents the dirt particles from sticking to the cleaning elements and merely circulating along the direction of movement.

In an advantageous design, it may be provided that the dirt particles are deflected from a transport direction by the suction device in an area between the cleaning elements. The trajectory of the dirt particles is preferably a hyperbolic trajectory. This allows the dirt particles to be removed from the contaminated surface.

In an advantageous design, it may be provided that the dirt particles are accelerated through the at least two cleaning elements. Preferably, the dirt particles are accelerated in the direction of the suction device. This allows a dynamic flow to be achieved, which efficiently removes the dirt particles adhering to the contaminated surface from the surface.

To solve the aforementioned object, the invention provides features intended for use in cleaning a moving and contaminated surface and, additionally or alternatively, for transporting particles on a surface. A cleaning device according to one of the features mentioned above is used for this purpose.

### BRIEF DESCRIPTION OF THE DRAWINGS

The invention is now described in more detail with reference to a few exemplary embodiments, but is not limited to these few exemplary embodiments. Further variants of the invention and exemplary embodiments result from combining the features of individual or several claims with each other and/or with individual or several features of the exemplary embodiments and/or the previously described variants of devices and methods according to the invention, wherein:

FIG. 1 shows a cleaning device in perspective view in the prior art,

FIG. 2 shows the cleaning device from FIG. 1 in a side view in the prior art,

FIG. 3 shows a cleaning device according to the invention in a side view,

FIG. 4 shows a cleaning device in a perspective view with the surface of mirror-symmetrical cleaning elements on both sides,

FIG. 5 shows a cleaning element in a detailed view,

FIG. 6 shows the cleaning device from FIG. 4 in a perspective view with the surface on both sides and mirror-symmetrical suction devices and

FIG. 7 shows the cleaning device from FIG. 6 in a side view,

FIG. 8 shows a cleaning device in a side view, wherein the cleaning device comprises more than two cleaning elements which engage on both sides and in mirror symmetry with the contaminated surface,

FIG. 9 shows a cleaning device in a perspective view, wherein the cleaning elements have the same permeability, and

FIG. 10 shows a cleaning device in a perspective view, wherein the cleaning elements have different permeability.

### DETAILED DESCRIPTION

In the following description of various exemplary embodiments of the invention, elements that have the same function are assigned the same reference numbers, even if their design or shape differs.

For clarity, not all reference signs are shown in the figures, although the elements may well be present in the figures. However, identical reference signs denote components and functional units that are identical in terms of function and/or design.

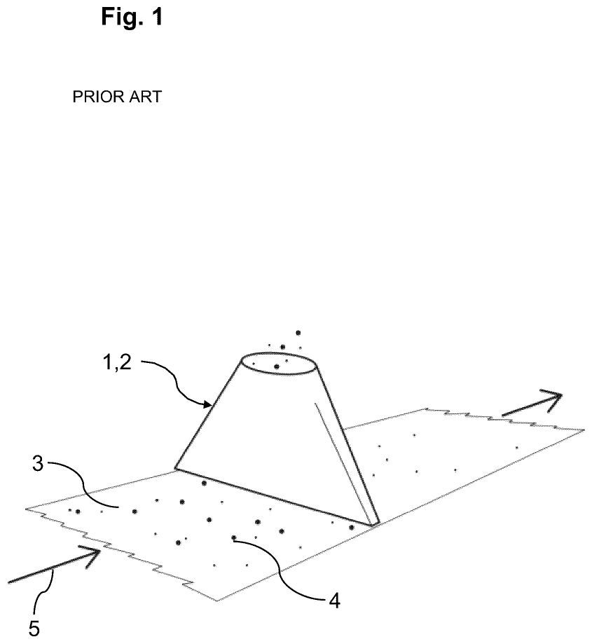

FIG. 1 shows a cleaning device 1 in a perspective view in the prior art. The cleaning device 1 has a suction device 2, which is spaced apart from a contaminated surface 3 on which dirt particles 4 are located and which is moved in a transport direction 5. The cleaning device 1 in FIG. 1 is particularly well suited for surfaces 3 that move at a low speed (less than 1 meter per second) and where the dirt particles 4 exert little or no adhesive force on the surface 3.

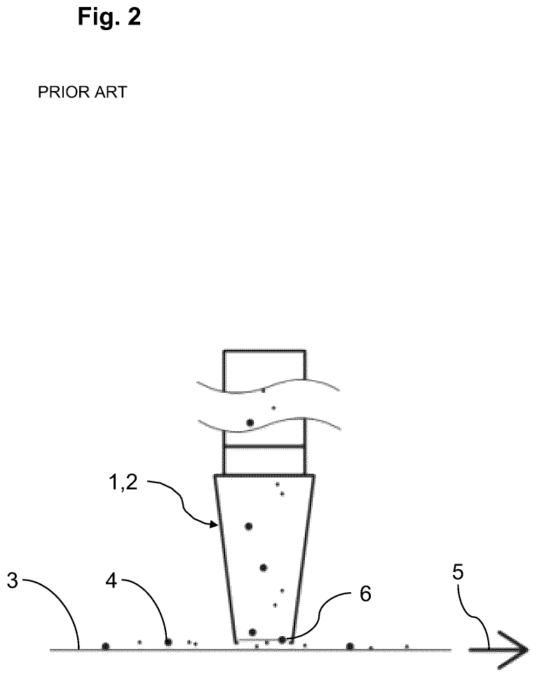

FIG. 2 shows the cleaning device 1 from FIG. 1 in a side view in the prior art. The funnel-shaped suction device 2 is shown in more detail, wherein the suction device 2 has a slot opening 6 through which the dirt particles 4 are passed. At higher speeds of the surface 3, in particular at speeds greater than 1 meter per second, and with dirt particles 4 adhering to the surface 3, not all dirt particles 4 can be removed from the surface 3. This can be disadvantageous in situations where a clean surface 3 is necessary, for example for a downstream process.

The surface 3 can be made of wood, paper, metal, glass, or plastic.

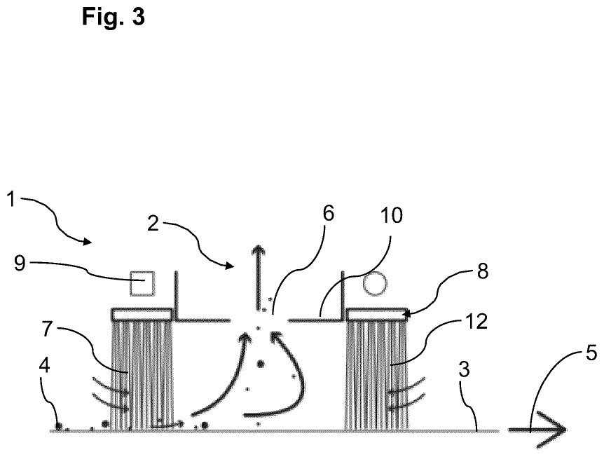

FIG. 3 shows a cleaning device 1 according to the invention in a side view. The cleaning device 1 has two cleaning elements 7, which are designed as bristle belts 8. The bristle belts 8 comprise bristles 12. The bristles 12 are movable. Between the cleaning elements 7 there is a suction device 2 which has a slot opening 6 through which it can extract dirt particles 4 removed by the cleaning elements 7. The suction device 2 is located vertically and above the surface 3. The cleaning elements 7 have identical permeability. In an alternative embodiment, the cleaning elements 7 have different permeability, with the cleaning element 7 upstream in the transport direction 5 having higher permeability. Permeability here refers to the flowability of the cleaning elements. The direction of movement 9 of the cleaning elements 7 is in the direction of the paper sheet (represented by a square) or in the direction away from the paper sheet (represented by a circle). The direction of movement 9 is opposite in the specific example. In alternative embodiments, the direction of movement 9 may be the same. Next to the slot opening 6 is a collection unit 10 in which dirt particles 4 can be collected. This is particularly advantageous in situations where the dirt particles 4 have a higher mass and cannot be completely extracted by the suction device 2 and remain in the suction device 2. The dirt particles 4 that have a higher mass and therefore cannot be extracted by the suction device 2 accumulate in the collection unit 10. The concentration of dirt particles 4 increases in the collection unit 10. The collection unit 10 is preferably emptied manually, i.e., by hand. Alternatively, the collection unit 10 can be emptied automatically by an emptying device (not shown here).

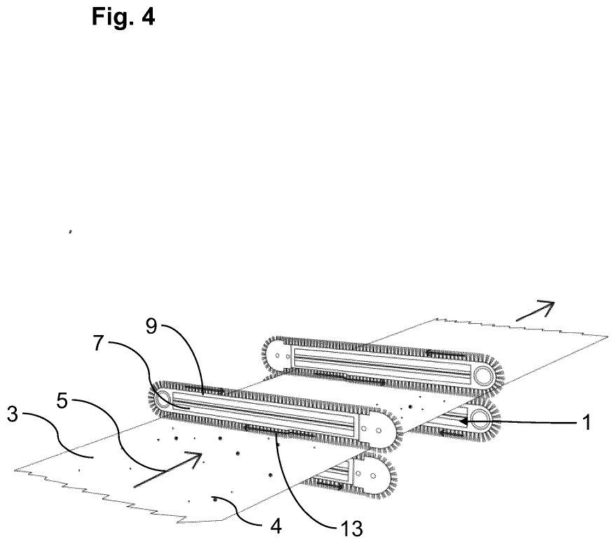

FIG. 4 shows a cleaning device 1 in a perspective view with the surface 3 of mirror-symmetrical cleaning elements 7 on both sides. The arrows symbolize the contaminated surface 3 moving in the transport direction 5. In the specific example, four cleaning elements 7 are formed with steps 13, wherein the cleaning elements 7 have identical permeability. In an alternative exemplary embodiment, the cleaning elements 7 upstream in the transport direction 5 have a higher permeability. This allows the dirt particles 4 to be efficiently sucked through the bristle belts 8 and accelerated toward a suction device 2 (not shown here). In the specific example, the direction of movement 9 of the cleaning elements 7 is opposite. In an alternative exemplary embodiment, the direction of movement 9 of the cleaning elements 7 may be the same.

The different permeabilities of the cleaning elements 7 can be achieved by flow channels 11, which are arranged transversely to the direction of movement 9 of the cleaning elements 7 and are preferably designed to be straight.

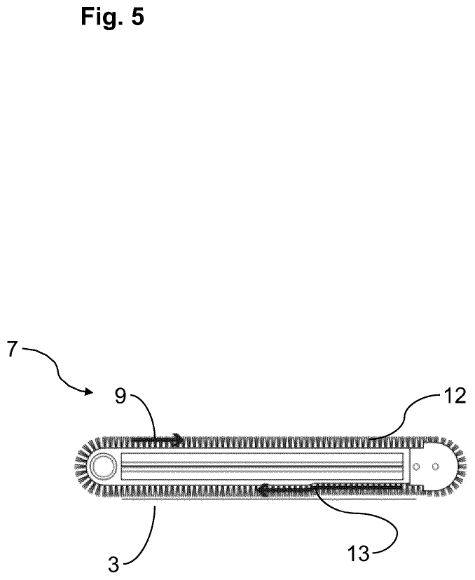

FIG. 5 shows a cleaning element 7 in a detailed view. The cleaning element 7 has a step 13, wherein in an area in a direction of movement 9 in front of the step 13, the bristles 12 of the cleaning element 7 are raised from the contaminated surface 3. This is to ensure that the cleaning element 7 cannot damage the surface 3 during operation. The surface 3 is shown as a line in the specific example.

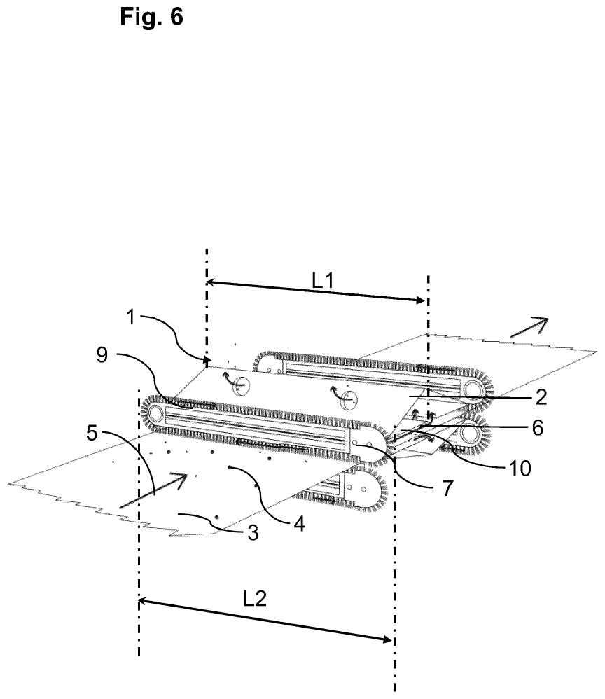

FIG. 6 shows the cleaning device 1 from FIG. 4 in a perspective view with the surface 3 and mirror-symmetrical suction devices 2 on both sides. The suction devices 2 have slot openings 6 through which the dirt particles 4 are sucked in. Collection units 10 are formed next to the slot openings 6. The larger arrows symbolize the transport direction 5 of the contaminated surface 3, while the medium-sized arrows symbolize the direction of movement 9 of the cleaning elements 7. The smallest arrows represent the trajectory of the dirt particles 4 within the suction devices 2. The direction of movement 9 is transverse to the transport direction 5.

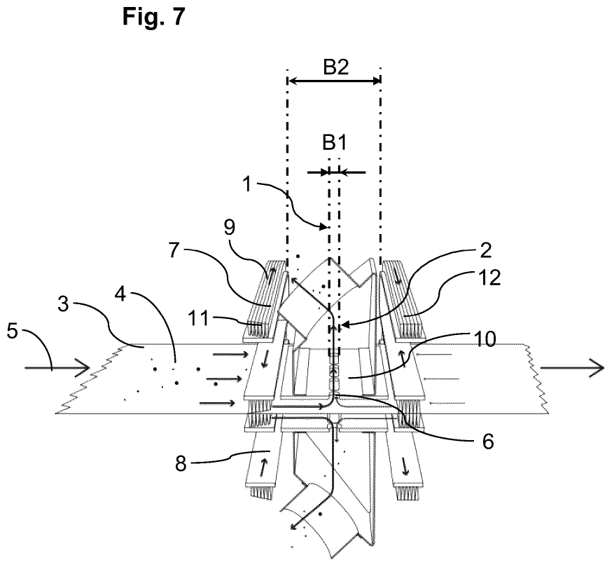

FIG. 7 shows the cleaning device 1 from FIG. 6 in a side view. The cleaning elements 7 upstream in the transport direction 5 have a higher permeability than the downstream cleaning elements 7. The different permeabilities of the cleaning elements 7 can be achieved by flow channels 11, which are arranged transversely to the direction of movement 9 of the cleaning elements 7 and are preferably designed to be straight. The cleaning device 1 is arranged on both sides and mirror-symmetrically to the contaminated surface 3.

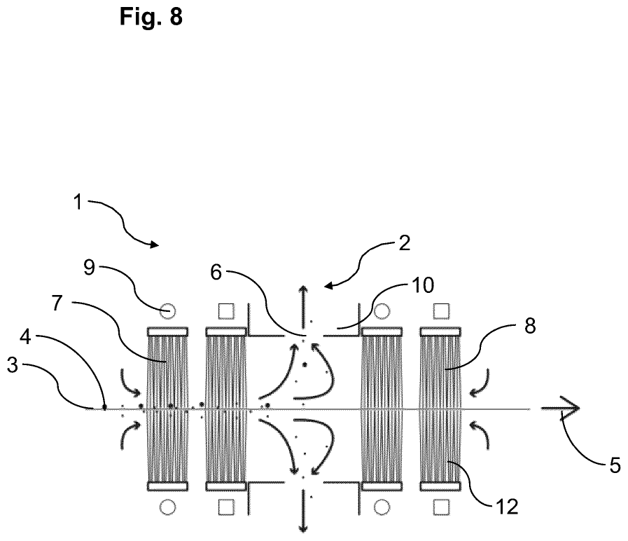

FIG. 8 shows a cleaning device 1 in a side view, wherein the cleaning device 1 comprises more than two cleaning elements 7, which engage on both sides and in a mirror-symmetrical manner with the contaminated surface 3. The cleaning elements 7 upstream in the transport direction 5 run in opposite directions to each other. The downstream cleaning elements 7 also run in opposite directions to each other. The suction devices 2 are arranged between the cleaning elements 7. A total of eight cleaning elements 7 are shown in FIG. 8. The dirt particles 4 are sucked off on a hyperbolic trajectory and enter the suction devices 2.

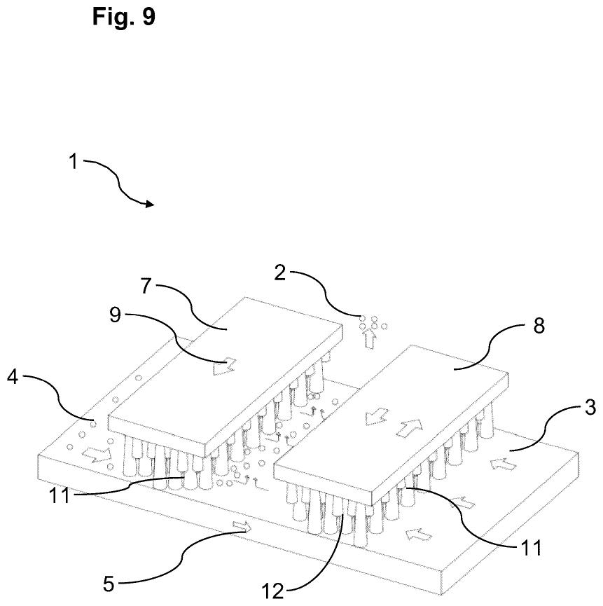

FIG. 9 shows a cleaning device 1 in a perspective view, wherein the cleaning elements 7 have the same permeabilities. A suction device 2 (shown here only symbolically) is arranged between the cleaning elements 7. The permeabilities of the cleaning elements 7 are achieved by flow channels 11, which are arranged transversely to the direction of movement 9 of the cleaning elements 7 and are preferably designed to be straight. The cleaning elements 7, which are designed as bristle belts 8, are either co-rotating or counter-rotating. The flow channels 11 are formed by bristles 12 of different lengths or by a bristle-free partial body. The identical rotation or opposite rotation of the cleaning elements 7 is determined by the surface 3 to be cleaned, the dirt particles 4, and the degree of contamination. The suction device 2 is arranged vertically and above the surface 3 to be cleaned. The suction device 2 is arranged along a normal vector of the surface 3.

The arrows indicating the direction of movement 9 are shown to illustrate the two cases of cleaning elements 7 moving in the same direction and cleaning elements 7 moving in opposite directions.

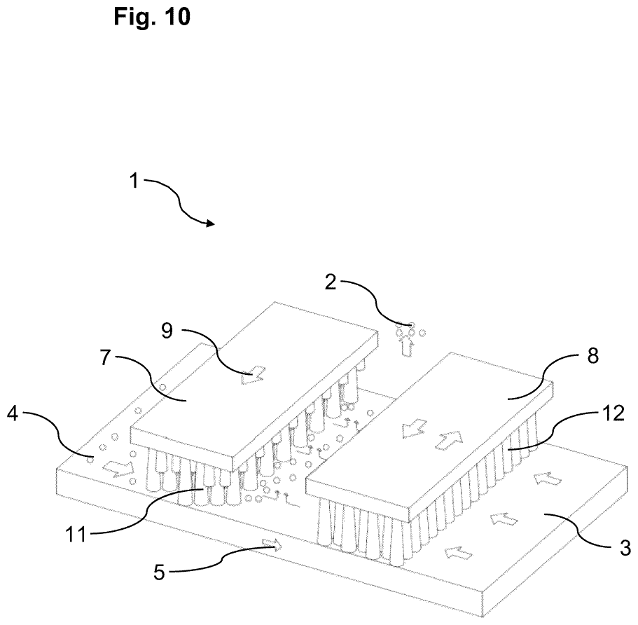

FIG. 10 shows a cleaning device 1 in a perspective view, wherein the cleaning elements 7 have different permeabilities. The cleaning elements 7 are designed as bristle belts 8. The cleaning element 7 upstream in the transport direction 5 has a higher permeability than the cleaning element 7 downstream. The downstream cleaning element 7 is designed as a fully bristled body and has no flow channels 11. The cleaning elements 7 can be designed to run in opposite or the same direction. The opposite rotation or identical rotation of the cleaning elements 7 is determined by the surface 3 to be cleaned, the dirt particles 4, and the degree of contamination.

In FIGS. 7 and 8, it can be seen that the suction device 2 has a slot opening 6 whose width B1 is smaller than a spacing B2 between the at least two cleaning elements 7 and through which the dirt particles 4 can be sucked out. It can also be seen that the slot opening 6 has a longitudinal extension L1 that is greater than half, in particular greater than three quarters, of a length L2 of at least one of the cleaning elements 7. The longitudinal extension L1 is measured here from the beginning to the end of the multi-part slot opening 6 without taking into account any interruptions.

In a cleaning device 1 with at least two cleaning elements 7, which are spaced apart and rotatable, wherein the cleaning elements 7 have movable bristles 12, it is proposed that a suction device 2 be arranged between the at least two cleaning elements 7.

### LIST OF REFERENCE SIGNS

1 Cleaning device
2 Suction device
3 Surface
4 Dirt particles
5 Transport direction
6 Slot opening
7 Cleaning element
8 Bristle belt
9 Direction of movement
10 Collection unit
11 Flow channel
12 Bristles
13 Step
L1 Longitudinal extension
L2 Length
B1 Width
B Spacing

1. A cleaning device (1), comprising:
at least two cleaning elements (7) which are spaced apart from one another and movable, the cleaning elements (7) have movable bristles (12), and
a suction device (2) is arranged between the at least two cleaning elements (7).

2. A cleaning device (1), comprising:
at least two cleaning elements (7) which are spaced apart from one another and movable, the cleaning elements (7) have movable bristles (12), and
the at least two cleaning elements (7) have a different permeability.

3. The cleaning device (1) according to claim 1, further comprising a transport device (5) adapted to create a relative movement of a contaminated surface (3) relative to the cleaning elements (7) in a transport direction (5).

4. The cleaning device (1) according to claim 1, wherein the at least two cleaning elements (7) comprise at least one of bristle rollers or bristle belts (8).

5. The cleaning device (1) according to claim 1, further comprising a suction device (2) that is adapted to create a negative pressure between the at least two cleaning elements (7).

6. The cleaning device (1) according to claim 3, wherein a distance between the bristles (12) and the contaminated surface (3) is not constant in an area of the surface (3).

7. The cleaning device (1) according to claim 3, wherein the cleaning elements (7) move in a direction of movement (9) which is arranged transversely to the transport direction (5) of the contaminated surface (3).

8. The cleaning device (1) according to claim 3, wherein one of the at least two cleaning elements (7) has flow channels (11) that are at least one of transverse to the transport direction (5) of the contaminated surface (3) or transverse to the direction of movement (9) of the at least two cleaning elements (7).

9. The cleaning device (1) according to claim 1, wherein the at least two cleaning elements (7) have a same permeability.

10. The cleaning device (1) according to claim 8, wherein the flow channels (11) are formed by bristles (12) of different lengths or by a bristle-free partial body.

11. The cleaning device (1) according to claim 1 wherein the cleaning elements (7) are operated in opposite directions relative to one another or in a same direction.

12. The cleaning device (1) according to claim 1, further comprising scrapers that at least one of a) are arranged at a reversal point of the cleaning elements (7), or b) contact the cleaning elements (7) and strip dirt particles (4) from the cleaning elements (7).

13. The cleaning device (1) according to claim 12, wherein the scrapers have a separate suction unit which is adapted to suction off the dirt particles (4) scraped off by the scrapers.

14. The cleaning device (1) according to claim 1, wherein the at least two cleaning elements (7) have flow channels (11) of different dimensions and permeabilities, and the flow channels (11) are arranged transversely to one or the direction of movement (9) of the cleaning elements (7).

15. The cleaning device (1) according to claim 14, wherein the flow channels (11) are designed to be straight.

16. The cleaning device (1) according to claim 14, wherein an angle α between a longitudinal axis of the flow channels (11) and a width of the cleaning element (7) is between 0° and 60°.

17. The cleaning device (1) according to claim 1, further comprising a suction device (2) having a collection unit (10) for collecting dirt particles (4).

18. The cleaning device (1) according to claim 3, wherein the cleaning element (7) connected upstream in the transport direction (5) of the contaminated surface (3) has a higher permeability than the cleaning element (7) connected downstream.

19. The cleaning device (1) according to claim 14, wherein angles (α) between a longitudinal axis of the flow channels (11) and a width of the respective cleaning element (7) of the at least two cleaning elements (7) are different.

20. The cleaning device (1) according to claim 1, further comprising a suction device (2) that has a slot opening (6) whose width (B1) is smaller than a spacing (B2) between the at least two cleaning elements (7) and through which dirt particles (4) can be suctioned out, or the slot opening (6) for extracting the dirt particles (4) has a longitudinal extension (L1) which is greater than half of a length (L2) of at least one of the cleaning elements (7).

21. The cleaning device (1) according to claim 21, wherein the suction device (2) has a funnel-shaped base body, in a bottom of which the slot opening (6) and a collection unit (10) are formed adjacent to each other.

22. The cleaning device (1) according to claim 3, wherein the at least two cleaning elements (7) are arranged on both sides and mirror-symmetrically to the contaminated surface (3).

23. The cleaning device (1) according to claim 20, wherein two of the suction devices (2) are formed, which are arranged on both sides and mirror-symmetrically with respect to a contaminated surface (3) that is adapted to be moved relative to the cleaning elements (7) in a transport direction (5).

24. The cleaning device (1) according to claim 23, wherein the transport direction (5) of the contaminated surface (3) and a movement direction (9) of the cleaning elements (7) are arranged transversely to each other.

25. The cleaning device (1) according to claim 23, wherein the at least two cleaning elements (7) have a step (13), wherein in a region in front of the step (13) the bristles (12) of the cleaning element (7) are raised from the contaminated surface (3).

26. A method for cleaning a contaminated surface (3), the method comprising:
guiding dirt particles (4) using at least two movable cleaning elements (7) of different permeability, and
the cleaning elements (7) comprise bristles (12), and the bristles are suctioned off by a suction device (2) located between the at least two movable cleaning elements (7).

27. The method according to claim 26, further comprising cleaning off the at least two cleaning elements (7) of the dirt particles (4) by scrapers which contact the at least two cleaning elements (7) at ends thereof.

28. The method according to claim 26, wherein the bristles (12) of the cleaning elements (7) are guided out of a cleaning area for cleaning of the bristles.

29. The method according to claim 26, further comprising deflecting the dirt particles (4) in a region between the cleaning elements (7) from a transport direction (5) by the suction device (2).

30. The method according to claim 26, further comprising accelerating the dirt particles (4) through the at least two cleaning elements (7), in a direction of the suction device (2).

31. (canceled)
